(19) United States
(12) Patent Application Publication
(10) Pub. No.: US 2026/0302385 A1
(43) Pub. Date: Oct. 1, 2026

(54) SOLID-STATE BATTERY AND METHOD FOR MANUFACTURING SOLID-STATE BATTERY

(71) Applicant: HONDA MOTOR CO., LTD., Tokyo (JP)

(72) Inventors: Yuki TASHIRO, Saitama (JP); Yohei NOJI, Saitama (JP); Kyohei YAMAGUCHI, Saitama (JP); Kazuma OUE, Saitama (JP); Kosuke TATSUSHIMA, Saitama (JP); Kenta UMETSU, Saitama (JP)

(21) Appl. No.: 19/570,154

(22) Filed: Mar. 18, 2026

(30) Foreign Application Priority Data
Mar. 25, 2025 (JP) 2025-049293

(51) Int. Cl. H01M 10/42; H01M 10/0585

(52) U.S. Cl. CPC H01M 10/4235; H01M 10/0585

(57) ABSTRACT

To provide a solid-state battery capable of suppressing cracking of an intermediate layer during manufacturing and suppressing a decrease in the electrical characteristics of the intermediate layer accompanying charge and discharge. A solid-state battery includes a laminated structure in which a negative electrode layer, an intermediate layer, a solid electrolyte layer, and a positive electrode layer are laminated in this order. The intermediate layer includes a fibrous material. The fibrous material has a length in a longitudinal direction that is greater than a thickness of the intermediate layer in a laminating direction of the laminated structure.

This application is based on and claims the benefit of priority from Japanese Patent Application No. 2025-049293, filed on 25 Mar. 2025, the content of which is incorporated herein by reference.

### BACKGROUND OF THE INVENTION

### Field of the Invention

The present invention relates to a solid-state battery and a method for manufacturing a solid-state battery.

### Related Art

In recent years, research and development has been conducted on secondary batteries that contribute to energy efficiency in order to ensure that more people have access to affordable, reliable, sustainable, and advanced energy.

As such secondary batteries, solid-state batteries such as lithium metal batteries and lithium ion secondary batteries in which a solid electrolyte layer is disposed between a positive electrode layer and a negative electrode layer are known. Japanese Unexamined Patent Application, Publication No. 2023-124804 discloses an invention relating to an all-solid-state battery including a protective layer capable of inducing uniform deposition and storage of lithium ions, and a method for manufacturing the same.

Patent Document 1: Japanese Unexamined Patent Application, Publication No. 2023-124804

### SUMMARY OF THE INVENTION

In the technique related to a solid-state battery, it is effective to dispose an intermediate layer for the purpose of uniformly depositing lithium on the negative electrode layer. The intermediate layer is disposed between the negative electrode layer and the solid electrolyte layer, and has conductivity of a charge transfer medium (hereinafter referred to as lithium ions). The intermediate layer includes a material having electron conductivity or lithium ion conductivity, such as a metal material or a carbon material.

The intermediate layer is configured as a softer layer than the other layers. Therefore, there is an issue that cracking may occur in the intermediate layer when the layers are press-bonded during manufacturing of the solid-state battery.

Further, there is an issue that a material such as a carbon material in the intermediate layer becomes non-uniform by repeating charging and discharging of the solid-state battery. FIG. 3 is a schematic cross-sectional view showing a state of a conventional solid-state battery during charging. In FIG. 3, an intermediate layer 5a is laminated between a negative electrode active material layer 21 and a solid electrolyte layer 4. FIG. 3 shows a state in which lithium ions move from the solid electrolyte layer 4 side to the negative electrode active material layer 21 side as proceeding in the direction of the arrow, and charging of the solid-state battery progresses. As shown in FIG. 3, the intermediate layer 5a includes a material such as a carbon material 51 having lithium ion conductivity. The carbon material 51 can expand and contract with the transfer of lithium ions. The intermediate layer 5a itself also expands and contracts along with the carbon material 51.

Although FIG. 3 shows a state during charging, the carbon material 51 and the intermediate layer 5a can expand and contract similarly during discharging. As a result, as shown in FIG. 3, the carbon material 51 may be sparse at some portions and dense at other portions in the intermediate layer 5a. At the portions where the carbon material 51 is sparse, the electron conduction path is interrupted, leading to an issue that the carbon material 51 cannot contribute to charging and discharging of the solid-state battery. Further, due to the expansion and contraction, the bonding at the interface between the intermediate layer 5a and the negative electrode active material layer 21 or the solid electrolyte layer 4 may not be maintained. In this case, there is also an issue that lithium ions are not transferred at a portion where the bonding of the interface is not maintained.

The present invention has been made in view of the above-described issues, and an object of the present invention is to provide a solid-state battery capable of suppressing cracking of an intermediate layer during manufacturing and suppressing a decrease in the electrical characteristics of the intermediate layer accompanying charge and discharge.

A first aspect of the present invention is a solid-state battery including a laminated structure in which a negative electrode layer, an intermediate layer, a solid electrolyte layer, and a positive electrode layer are laminated in this order. The intermediate layer includes a fibrous material. The fibrous material has a length in a longitudinal direction that is greater than a thickness of the intermediate layer in a laminating direction of the laminated structure.

In a second aspect of the present invention according to the first aspect, the fibrous material is a vapor grown carbon fiber.

In a third aspect of the present invention according to the first or second aspect, the thickness of the intermediate layer is 1 μm or more and 10 μm or less.

In a fourth aspect of the present invention according to any one of the first to third aspects, the intermediate layer has a content of the fibrous material of 1% by mass or more and 50% by mass or less.

In a fifth aspect of the present invention according to any one of the first to fourth aspects, the intermediate layer has a content of the fibrous material of 10% by mass or more and less than 20% by mass.

In a sixth aspect of the present invention according to any one of the first to fifth aspects, the intermediate layer has an elastic modulus of 0.2 GPa or more and 0.6 GPa or less.

In a seventh aspect of the present invention according to any one of the first to sixth aspects, the intermediate layer has a porosity of 40% or more and 70% or less.

In an eighth aspect of the present invention according to any one of the first to seventh aspects, the intermediate layer includes the fibrous material, at least one of a metal material or a carbon material, and a binder.

In a ninth aspect of the present invention according to any one of the first to eighth aspects, one end of a part of the fibrous material present in the intermediate layer reaches at least one of the negative electrode layer or the solid electrolyte layer.

A tenth aspect of the present invention is a method for manufacturing the solid-state battery according to any one of claims 1 to 9. The method includes integration including laminating and pressing the negative electrode layer, the intermediate layer, the solid electrolyte layer, and the positive electrode layer to integrate them. A pressing pressure in the integration is 800 MPa or more and 1200 MPa or less.

According to the present invention, it is possible to provide a solid-state battery capable of suppressing cracking of an intermediate layer during manufacturing and suppressing a decrease in the electrical characteristics of the intermediate layer accompanying charge and discharge.

### BRIEF DESCRIPTION OF THE DRAWINGS

FIG. 1 is a cross-sectional view schematically showing the structure of a solid-state battery according to an embodiment of the present invention;

FIG. 2 is a cross-sectional view schematically showing a state of an intermediate layer during charging of the solid-state battery according to the embodiment of the present invention;

FIG. 3 is a cross-sectional view schematically showing a state of an intermediate layer during charging of a solid-state battery according to conventional art;

FIG. 4 is a graph showing the relationship between pressing pressure and nanoindenter elastic modulus in Examples and a Comparative Example of the present invention; and

FIG. 5 is a graph showing the relationship between pressing pressure and porosity in the Examples and Comparative Example of the present invention.

### DETAILED DESCRIPTION OF THE INVENTION

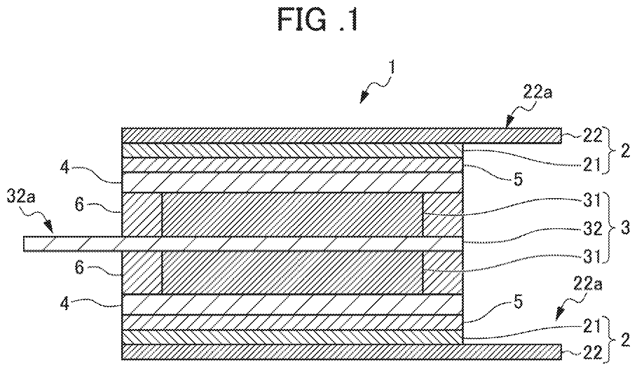

FIG. 1 is a cross-sectional view schematically showing the structure of a solid-state battery 1 according to the present embodiment. As shown in FIG. 1, the solid-state battery 1 includes a laminated structure in which a negative electrode layer 2, an intermediate layer 5, a solid electrolyte layer 4, and a positive electrode layer 3 are laminated in this order. FIG. 1 is an example of a solid-state battery, and the configuration of the solid-state battery is not limited to the configuration of FIG. 1. For example, although the configuration of FIG. 1 shows a configuration with two negative electrode layer 2 and one positive electrode layer 3, the number of laminated layers in each layer of the solid-state battery 1 is not limited to the configuration of FIG. 1. The solid-state battery 1 may be a lithium ion solid-state secondary battery or a lithium metal secondary battery.

### Negative Electrode Layer

The negative electrode layer 2 includes a negative electrode active material layer 21 and a negative electrode current collector layer 22. The negative electrode active material layer 21 is not particularly limited, and may include a material that can be used as a negative electrode active material of a solid-state battery. The negative electrode active material layer 21 is preferably a lithium metal or lithium alloy layer in which the negative electrode active material is a lithium metal or a lithium alloy. This is because the solid-state battery 1 according to the present embodiment includes the intermediate layer 5 and dendrite formation is uniformized. The metal capable of being alloyed with lithium as the lithium metal alloy is not particularly limited, and examples thereof include one or more metals selected from the group consisting of Sn, Ag, Mg, In, Si, Al, Bi, Sb, Zn, and Cu. Alternatively or additionally, the negative electrode active material layer 21 may include a silicon-based active material such as Si or an Si alloy, a lithium transition metal oxide such as lithium titanate (Li₄Ti₅O₁₂), a transition metal oxide such as TiO₂, Nb₂O₃, or WO₃, a metal sulfide, a metal nitride, a carbon material such as graphite, soft carbon, or hard carbon, metal indium, or the like.

Additionally, the negative electrode active material layer 21 may contain materials that can be contained in a negative electrode active material layer of a solid-state battery. Examples of the materials include a solid electrolyte, a conductivity aid, and a binder. Examples of the conductivity aid include carbon black, natural graphite, carbon fibers, and carbon nanotubes. Examples of the solid electrolyte and the binder include the same solid electrolyte materials and binders as those contained in the solid electrolyte layer 4 described below.

The negative electrode current collector layer 22 is not particularly limited, and may include copper, nickel, stainless steel, or the like. Examples of the shape of the negative electrode current collector layer 22 include a foil shape, a plate shape, a mesh shape, a nonwoven fabric shape, and a foamed shape. A part of the negative electrode current collector layer 22 extends in a predetermined direction to form a negative electrode current collector tab 22a.

### Positive Electrode Layer

The positive electrode layer 3 includes a positive electrode active material layer 31 and a positive electrode current collector layer 32. In the present embodiment, the positive electrode layer 3 has a configuration in which two positive electrode active material layers 31 are respectively laminated on both surfaces of one positive electrode current collector layer 32. However, the configuration of the positive electrode layer 3 is not limited to the above, and the positive electrode layer 3 may have a configuration in which one positive electrode active material layer 31 is laminated on one surface of one positive electrode current collector layer 32.

The positive electrode active material layer 31 is not particularly limited, and may include a material that can be used as a positive electrode active material of a solid-state battery. Examples of the positive electrode active material constituting the positive electrode active material layer 31 include layered positive electrode active material particles such as LiCoO₂, LiNiO₂, LiCoₓNi_{y}Mn_{z}O₂ (x+y+z=1), LiVO₂, and LiCrO₂, spinel type positive electrode active materials such as LiMn₂O₄, Li(Ni_{0.25}Mn_{0.75})₂O₄, LiCoMnO₄, and Li₂NiMn₃O₈, olivine type positive electrode active materials such as LiCoPO₄, LiMnPO₄, and LiFePO₄, solid solution oxides (Li₂MnO₃—LiMO₂ (M=Co, Ni, or the like)), conductive polymers such as polyaniline and polypyrrole, sulfides such as Li₂S, CuS, Li—Cu—S compounds, TiS₂, FeS, MoS₂, and Li—Mo—S compounds, and mixtures of sulfur and carbon. The positive electrode active material may include one of the above materials, or may include two or more of the above materials.

Additionally, the positive electrode active material layer 31 may contain materials that can be contained in a positive electrode active material layer of a solid-state battery, such as a solid electrolyte, a conductivity aid, and a binder. Examples of the materials include the same materials as those that can be contained in the negative electrode active material layer 21.

An insulating frame 6 may be provided on the outer peripheral portion of the positive electrode active material layer 31. The insulating frame 6 can prevent short-circuits in the solid-state battery 1 and improve the strength. In the present embodiment, the insulating frame 6 is disposed so as to cover the side surfaces of the two positive electrode active material layers 31 respectively formed on both surfaces of the positive electrode current collector layer 32. The insulating frame 6 abuts against a part of the lamination surface of the positive electrode current collector layer 32 and has a gap through which a positive electrode current collector tab 32a described later extends. The material constituting the insulating frame 6 is not particularly limited, and examples thereof include insulating oxides such as alumina, resins such as polyvinylidene fluoride (PVDF), and rubbers such as styrene-butadiene rubber (SBR).

The positive electrode current collector layer 32 is not particularly limited, and may include, for example, aluminum, stainless steel, conductive carbon (graphite, carbon nanotube, or the like), or the like. Examples of the shape of the positive electrode current collector layer 32 include a foil shape, a plate shape, a mesh shape, a nonwoven fabric shape, and a foamed shape. A part of the positive electrode current collector layer 32 extends in a predetermined direction to form the positive electrode current collector tab 32a.

### Solid Electrolyte Layer

In the present embodiment, the solid electrolyte layer 4 is laminated between the intermediate layer 5 and the positive electrode layer 3. Although FIG. 1 shows a state in which one solid electrolyte layer 4 is laminated between the intermediate layer 5 and the positive electrode layer 3, the number of laminated solid electrolyte layers 4 between the intermediate layer 5 and the positive electrode layer 3 is not limited to one. For example, the number of laminated solid electrolyte layers 4 may be two or three or more. The solid electrolyte layer 4 contains a solid electrolyte material. The solid electrolyte material is not particularly limited, and examples thereof include a sulfide solid electrolyte material, an oxide solid electrolyte material, a halide solid electrolyte, an inorganic solid electrolyte such as a lithium-containing salt, and a polymer solid electrolyte such as polyethylene oxide. The above solid electrolyte materials may be used alone or in combination of two or more thereof.

Additionally, the solid electrolyte layer 4 may contain a binder. Examples of the binder include a fluorine-based resin, a nitrile-based polymer, a polyester-based polymer, an acrylic acid-based polymer, a cellulose-based polymer, a styrene-based polymer, a styrene-butadiene-based polymer, a vinyl acetate-based polymer, and a urethane-based polymer. The above binders may be used alone or in combination of two or more thereof.

### Intermediate Layer

The intermediate layer 5 is disposed between the negative electrode layer 2 and the solid electrolyte layer 4. The intermediate layer 5 is a layer having lithium ion conductivity. For example, when the solid-state battery 1 is a lithium metal battery, the intermediate layer 5 allows uniform deposition of lithium metal (dendrites). The solid-state battery 1 may be an anode-free battery in which the negative electrode active material layer 21 does not exist during the initial charge. In this case, a lithium metal layer as the negative electrode active material layer 21 is formed after the initial charge and discharge.

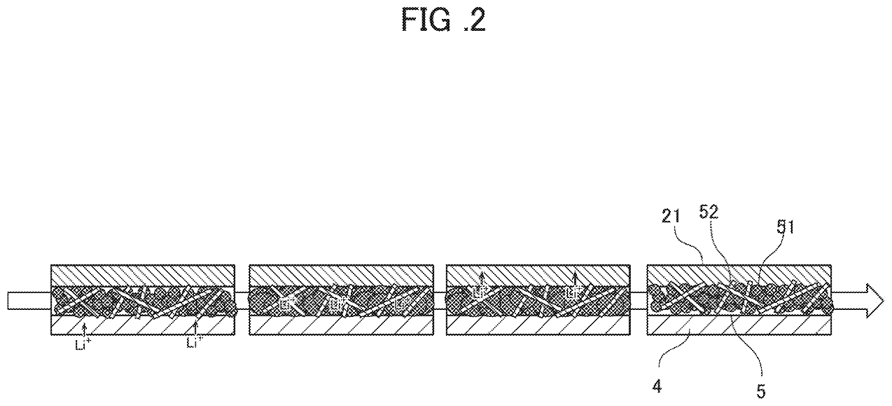

As shown in FIG. 2, the intermediate layer 5 contains a fibrous material 52. The intermediate layer 5 may contain a carbon material 51, a metal material, a binder, and the like in addition to the fibrous material 52. In the following description, the intermediate layer 5 contains the carbon material 51, but another material having electron conductivity may be used instead of the carbon material 51. The fibrous material 52 has a length in the longitudinal direction that is greater than the thickness of the intermediate layer 5 (thickness in the laminating direction of the laminated structure of the solid-state battery 1). By including the fibrous material 52 in the intermediate layer 5, the strength (elastic modulus and shear strength) of the intermediate layer 5 is improved. Therefore, it is possible to suppress the occurrence of cracking of the intermediate layer 5 when the intermediate layer 5 is pressed during manufacturing the solid-state battery 1. Additionally, by including the fibrous material 52 in the intermediate layer 5, the surface roughness of the intermediate layer 5 can be roughened. Specifically, as the amount of the fibrous material 52 added to the intermediate layer 5 increases, the surface roughness Sa (arithmetic average height), Sz (maximum height), and Sdr (developed area ratio of the interface) can all be increased. Accordingly, the bondability between the intermediate layer 5 and the negative electrode layer 2 or the solid electrolyte layer 4 can be improved.

One end of a part of the fibrous material 52 preferably reaches at least one of the negative electrode layer 2 or the solid electrolyte layer 4. In this case, the other end may be present in the intermediate layer 5, or may reach the solid electrolyte layer 4 or the negative electrode layer 2 that is an opposing layer. With the above-described configuration of the fibrous material 52, expansion and contraction (thickness change) of the intermediate layer 5 accompanying charge and discharge of the solid-state battery 1 can be suppressed. Additionally, it is considered that the presence of the fibrous material 52 across the interface between the intermediate layer 5 and the negative electrode layer 2 or the solid electrolyte layer 4 can increase the fine irregularities on the bonding surface and improve the bondability.

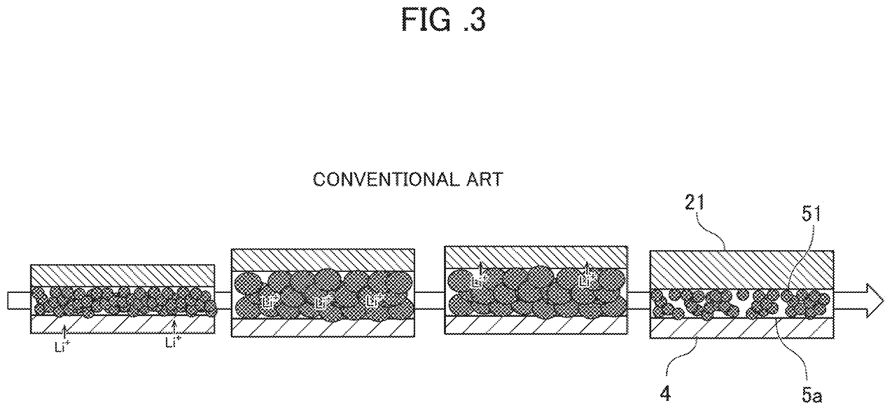

By including the fibrous material 52 in the intermediate layer 5, it is possible to suppress a decrease in the electrical characteristics of the intermediate layer 5 accompanying charge and discharge of the solid-state battery 1. The above effects will be described with reference to FIG. 2. FIG. 2 is a schematic cross-sectional view showing a state of the solid-state battery 1 during charging. In FIG. 2, the intermediate layer 5 is laminated between the negative electrode active material layer 21 and the solid electrolyte layer 4. FIG. 2 shows a state in which lithium ions move from the solid electrolyte layer 4 side to the negative electrode active material layer 21 side as proceeding in the direction of the arrow, and charging of the solid-state battery 1 progresses. As shown in FIG. 2, the intermediate layer 5 includes a material such as the carbon material 51 having lithium ion conductivity. The carbon material 51 can expand and contract with the transfer of lithium ions. The intermediate layer 5 itself also expands and contracts along with the carbon material 51. A conventional intermediate layer 5a not containing the fibrous material 52, as shown in FIG. 3, may have portions where the carbon material 51 is sparse and portions where the carbon material 51 is dense.

In the intermediate layer 5 according to the present embodiment, the movement of the carbon material 51 during charge and discharge of the solid-state battery 1 is restricted by the fibrous material 52. Therefore, it is possible to suppress the occurrence of portions where the carbon material 51 is sparse in the intermediate layer 5 accompanying charge and discharge. Therefore, it is possible to prevent the electron conduction path from being interrupted in a part of the intermediate layer 5 and from not contributing to charge and discharge.

The fibrous material 52 is preferably a conductive fiber. This allows the fibrous material 52 itself to ensure the electron conduction path, thereby improving the output characteristics and charge/discharge efficiency of the solid-state battery 1. Examples of such a conductive fiber include vapor grown carbon fiber (VGCF). VGCF has excellent conductivity and exhibits high tensile strength and elastic modulus. Therefore, by using VGCF as the fibrous material 52, it is possible to preferably improve the strength of the intermediate layer 5 in addition to ensuring the electron conduction path. Examples of the conductive fiber other than VGCF include carbon nanotubes (CNTs), graphene fibers, graphite fibers, PAN-based carbon fibers, and pitch-based carbon fibers.

The carbon material 51 is a material that is not fibrous, or a material that is fibrous but has a length in the longitudinal direction that is smaller than the thickness of the intermediate layer 5 in the laminating direction. The carbon material 51 may be in the form of particles or powder, for example. Examples of the carbon material include amorphous carbon. Examples of the amorphous carbon include carbon blacks such as acetylene black, furnace black, and Ketjenblack, coke, activated carbon, carbon nanotubes (CNT), fullerene, graphene, hard carbon, and soft carbon.

Examples of the metal material that can be contained in the intermediate layer 5 include metals that can be alloyed with lithium. Examples of such metals include tin (Sn), silicon (Si), zinc (Zn), magnesium (Mg), gold (Au), platinum (Pt), palladium (Pd), silver (Ag), aluminum (Al), bismuth (Bi), and antimony (Sb). These metals may be combined with carbon to form a composite. The metal capable of being alloyed with lithium may be in the form of nanoparticles.

Examples of the binder that can be contained in the intermediate layer 5 include the same binders as the binders that can be contained in the solid electrolyte layer 4.

The content of the fibrous material 52 in the intermediate layer 5 is preferably 1% by mass or more and 50% by mass or less. As a result, both the effect of suppressing cracking of the intermediate layer 5 during manufacturing and the effect of suppressing a decrease in the electrical characteristics of the intermediate layer 5 accompanying charge and discharge can be preferably obtained. The content of the fibrous material 52 is more preferably 10% by mass or more and less than 20% by mass. Accordingly, the strength of the intermediate layer 5 can be preferably improved, and the porosity of the intermediate layer 5 can be readily reduced. The content of the fibrous material 52 may be 10% by mass or more and 15% by mass or less, and may be 10% by mass or more and 13% by mass or less.

The content of the metal material in the intermediate layer 5 is preferably 20% by mass or more and 75% by mass or less, and more preferably 20% by mass or more and 30% by mass or less. The content of the carbon material 51 in the intermediate layer 5 is preferably 20% by mass or more and 75% by mass or less, and more preferably 40% by mass or more and 70% by mass or less. The content of the binder in the intermediate layer 5 is preferably 1% by mass or more and 10% by mass or less.

The above thickness of the intermediate layer 5 is preferably 1 μm or more and 10 μm or less. This enables the energy density of the solid-state battery to be improved. The above thickness of the intermediate layer 5 is more preferably 1 μm or more and 5 μm or less.

The elastic modulus of the intermediate layer 5 is preferably 0.2 GPa or more and 0.6 GPa or less. This can suppress cracking of the intermediate layer 5 during the manufacturing of the solid-state battery 1. The elastic modulus of the intermediate layer 5 is more preferably 0.3 GPa or more. The above elastic modulus means a nanoindenter elastic modulus at 25° C. measured by a nanoindentation test.

The porosity of the intermediate layer 5 is preferably 70% or less from the viewpoint of densification. The above porosity may be 50% or more, and may be 40% or more.

### Method for Manufacturing Solid-State Battery

A method for manufacturing the solid-state battery 1 according to the present embodiment will be exemplified below. The method for manufacturing the solid-state battery according to the present embodiment includes an integration pressing step of laminating and pressing the negative electrode layer 2, the intermediate layer 5, the solid electrolyte layer 4, and the positive electrode layer 3 to integrate them. The pressing pressure in the integration pressing step is 800 MPa or more and 1200 MPa or less. The integration pressing step may be performed at a temperature of, for example, 25° C. or more and 120° C. or less. By setting the pressing pressure in the integration pressing step within the above range, each layer can be densified and the energy density of the solid-state battery 1 can be improved. Since the strength of the intermediate layer 5 according to the present embodiment is improved by including the fibrous material 52, cracking of the intermediate layer 5 can be suppressed even when the pressing pressure in the integration pressing step is within the above range.

The method for manufacturing the solid-state battery 1 according to the present embodiment may include steps in addition to the integration pressing step. For example, the method may include a first lamination step of laminating the solid electrolyte layer 4 and the intermediate layer 5 to obtain a solid electrolyte layer-intermediate layer laminate, and a first pressing step of laminating and pressing the solid electrolyte layer-intermediate layer laminate and the positive electrode layer 3 to obtain an intermediate layer-solid electrolyte layer-positive electrode layer laminate. In this case, the integration pressing step is a step of laminating and pressing the intermediate layer-solid electrolyte layer-positive electrode layer laminate and the negative electrode layer 2 to integrate the layers. The first lamination step, the first pressing step, and the integration pressing step are performed in this order.

The first lamination step is a step of laminating the solid electrolyte layer 4 and the intermediate layer 5 to obtain a solid electrolyte layer-intermediate layer laminate. Examples of the method for laminating the solid electrolyte layer 4 and the intermediate layer 5 include a method in which a slurry obtained by dispersing a material constituting the intermediate layer 5 in a solvent is applied onto a substrate, dried, and then the solid electrolyte layer 4 is disposed on the intermediate layer 5. Alternatively, a method of disposing the solid electrolyte layer 4 on the intermediate layer 5 may be used. For example, a slurry obtained by dispersing a material constituting the solid electrolyte layer 4 in a solvent may be applied onto the intermediate layer 5 and dried. Alternatively, the solid electrolyte layer 4 formed by applying the slurry to a support sheet and drying the slurry may be transferred onto the intermediate layer 5. Alternatively, the solid electrolyte layer 4 formed in a sheet shape in advance may be disposed on the intermediate layer 5. After the solid electrolyte layer 4 is disposed on the intermediate layer 5, these layers may be pressed.

The first pressing step is a step of laminating and pressing the solid electrolyte layer-intermediate layer laminate and the positive electrode layer 3 to obtain an intermediate layer-solid electrolyte layer-positive electrode layer laminate.

Preferred embodiments of the present invention have been described above. The present invention is not limited to the contents of the above-described embodiments, and the contents of the above-described embodiments can be modified as appropriate within the scope that does not impair the effects of the present invention.

Hereinafter, the present invention will be described in more detail with reference to Examples. The present invention is not limited to the following Examples.

### EXAMPLES

### Preparation of Intermediate Layer

### Example 1

A slurry was prepared using tin (Sn) as a metal material, carbon black as a carbon material, VGCF (average length in the longitudinal direction: 1 to 10 μm) as a fibrous material, and a PVDF-based binder as a binder, and the slurry was applied onto a substrate and dried to obtain an intermediate layer according to Example 1. The content of VGCF in the intermediate layer was set to 10.7% by mass.

### Example 2

An intermediate layer according to Example 2 was obtained in the same manner as in Example 1 except that the content of VGCF was set to 20.0% by mass.

### Comparative Example 1

An intermediate layer according to Comparative Example 1 was obtained in the same manner as in Example 1 except that the fibrous material was not contained.

### Elastic Modulus Measurement

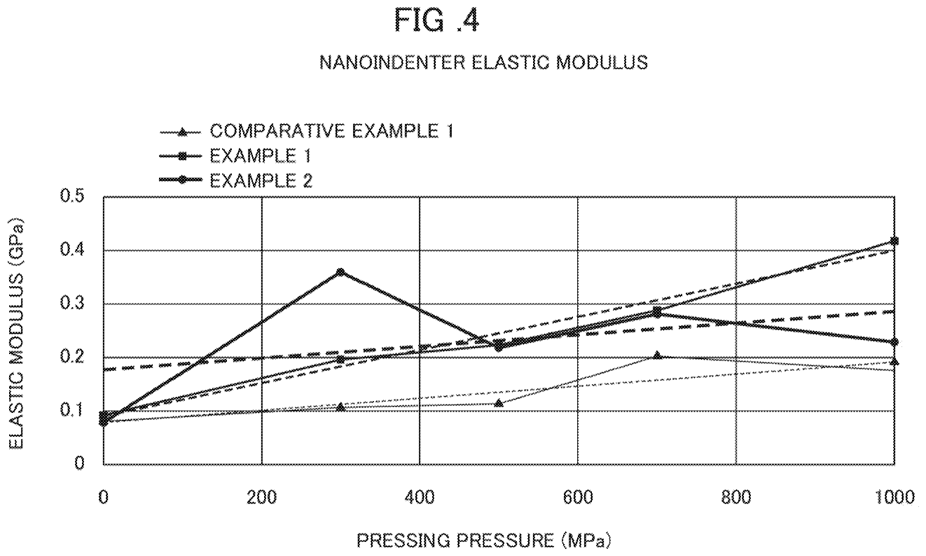

Each of the intermediate layers of the Examples and Comparative Example obtained as described above was pressed at different pressing pressures. The thickness of each intermediate layer after pressing at 1000 MPa was 3 82 m. The nanoindenter elastic modulus of each intermediate layer after pressing was measured. The nanoindenter elastic modulus was measured using a Hysitron TI-950 Triboindenter under pressing conditions of an indentation depth in the range of 100 nm to 300 nm and an indentation load in the range of 1 μN to 300 μN. The results are shown in FIG. 4. In FIG. 4, the vertical axis represents the nanoindenter elastic modulus (GPa), and the horizontal axis represents the pressing pressure (MPa). From the results shown in FIG. 4, it is clear that the intermediate layer according to each Example can improve the elastic modulus to a preferable range, compared to the intermediate layer according to Comparative Example 1.

### Porosity Measurement

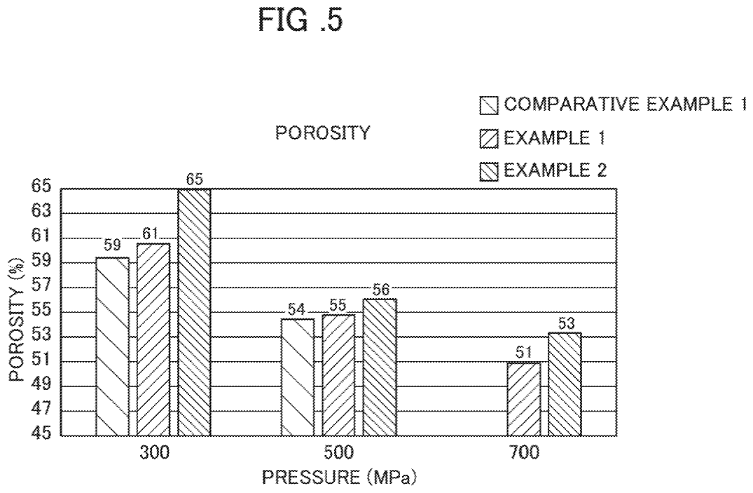

Each of the intermediate layers of the Examples and Comparative Example obtained as described above was pressed at different pressing pressures, and the porosity of each intermediate layer after pressing was measured. The porosity was calculated from the weight and thickness per unit area of the intermediate layer after pressing and the specific gravity of the material constituting the intermediate layer. The results are shown in FIG. 5. In FIG. 5, the vertical axis represents the porosity (%), and the horizontal axis represents the pressing pressure (MPa). The porosity of Comparative Example 1 at 700 MPa was not measured. From the results shown in FIG. 5, it is clear that the porosity of the intermediate layer according to each Example in which the fibrous material is contained can be reduced to the same level as that of Comparative Example 1 in which the fibrous material is not contained.

### EXPLANATION OF REFERENCE NUMERALS

1 solid-state battery
2 negative electrode layer
3 positive electrode layer
4 solid electrolyte layer
5 intermediate layer
52 fibrous material

What is claimed is:

1. A solid-state battery comprising a laminated structure in which a negative electrode layer, an intermediate layer, a solid electrolyte layer, and a positive electrode layer are laminated in this order,
the intermediate layer comprising a fibrous material, and
the fibrous material having a length in a longitudinal direction that is greater than a thickness of the intermediate layer in a laminating direction of the laminated structure.

2. The solid-state battery according to claim 1, wherein the fibrous material is a vapor grown carbon fiber.

3. The solid-state battery according to claim 1, wherein the thickness of the intermediate layer is 1 μm or more and 10 μm or less.

4. The solid-state battery according to claim 1, wherein the intermediate layer has a content of the fibrous material of 1% by mass or more and 50% by mass or less.

5. The solid-state battery according to claim 1, wherein the intermediate layer has a content of the fibrous material of 10% by mass or more and less than 20% by mass.

6. The solid-state battery according to claim 1, wherein the intermediate layer has an elastic modulus of 0.2 GPa or more and 0.6 GPa or less.

7. The solid-state battery according to claim 1, wherein the intermediate layer has a porosity of 40% or more and 70% or less.

8. The solid-state battery according to claim 1, wherein the intermediate layer comprises the fibrous material, at least one of a metal material or a carbon material, and a binder.

9. The solid-state battery according to claim 1, wherein one end of a part of the fibrous material present in the intermediate layer reaches at least one of the negative electrode layer or the solid electrolyte layer.

10. A method for manufacturing the solid-state battery according to claim 1, the method comprising:
integration pressing comprising laminating and pressing the negative electrode layer, the intermediate layer, the solid electrolyte layer, and the positive electrode layer to integrate them,
a pressing pressure in the integration pressing being 800 MPa or more and 1200 MPa or less.
